(19) United States
(12) Patent Application Publication
(10) Pub. No.: US 2010/0204355 A1
(43) Pub. Date: Aug. 12, 2010

(54) POLYMER NANOENCAPSULATED ACID-CATALYZED SOL-GEL SILICA MONOLITHS

(76) Inventors: Nicholas Leventis, Rolla, MO (US); Sudhir Mulik, Rolla, MO (US); Xiaojiang Wang, Akron, OH (US); Chariklia Sotiriou-Leventis, Rolla, MO (US)

Correspondence Address: CARR LLP, 670 FOUNDERS SQUARE, 900 JACKSON STREET, DALLAS, TX, 75202, US

(21) Appl. No.: 12/676,123

(22) PCT Filed: Sep. 5, 2008
(86) PCT No.: PCT/US08/75457

§ 371 Date: Apr. 30, 2010

Related U.S. Application Data
(60) Provisional application No. 60/970,741, filed on Sep. 7, 2007.
(60) Provisional application No. 60/970,742, filed on Sep. 7, 2007.
(60) Provisional application No. 61/091,286, filed on Aug. 22, 2008.

(30) Foreign Application Priority Data
Aug. 22, 2008 (US) PCT/US2008/074081

(51) Int. Cl. C08G 18/00; B05D 3/02

(52) U.S. Cl. 521/155; 427/385.5

(57) ABSTRACT

Macroporous monolithic silica aerogels having mesoporous walls are produced via an acid-catalyzed sol-gel process from tetramethoxysilane (TMOS) using a triblock co-polymer (Pluronic P123) as a structure-directing agent and 1,3,5-trimethylbenzene (TMB) as a micelle-swelling reagent. Pluronic P 123 was removed by solvent extraction, and monoliths were obtained by removing the pore-filling solvent with liquid CO₂, which was removed under supercritical conditions. The resulting materials are more robust compared to base-catalyzed silica aerogels of similar density. Mechanical properties can be further improved by reacting a di-isocyanate with the silanol groups on the macro and mesoporous surfaces. The polymer forms a conformal coat on the macropores and blocks access to the mesopores of templated samples, so that BET surface areas decrease dramatically.

### STATEMENT OF RELATED APPLICATIONS

This application relates to, and claims the benefit of the filing date of: co-pending U.S. provisional patent application Ser. No. 60/970,741 entitled POLYMER NANO-ENCAPSULATED ACID-CATALYZED SOL-GEL MESOPOROUS SILICA MONOLITHS, filed Sep. 7, 2007; co-pending U.S. provisional patent application Ser. No. 60/970,742 entitled BIDENTATE GEL CROSSLINKERS MATERIALS AND METHODS FOR MAKING AND USING THE SAME, filed Sep. 7, 2007; co-pending U.S. provisional patent application Ser. No. 61/091,286 entitled PRE-FORMED ASSEMBLIES OF SOLGEL-DERIVED NANOPARTICLES AS 3-D SCAFFOLDS FOR COMPOSITES AND AEROGELS, filed Aug. 22, 2008; and co-pending international patent application no. PCT/US08/74081 entitled PRE-FORMED ASSEMBLIES OF SOLGEL-DERIVED NANOPARTICLES AS 3-D SCAFFOLDS FOR COMPOSITES AND AEROGELS, filed Aug. 22, 2008; the entire contents of which are incorporated herein by reference for all purposes.

### BACKGROUND

1. Technical Field

Various aspects and embodiments relate generally to polymer encapsulation of nanostructures of composites, including aerogels, and materials and methods for making the same.

2. Description of the Related Art

The 1992 discovery by scientists at Mobil Corporation of the M41S™ series of ordered mesoporous silicas has drawn great interest in those materials because of their large surface area, uniform pore size distribution and their potential application in catalysis, sorption, and chromatography. Typically, M41S type of materials have pore sizes in the 20 to 30 Å range and are made via an aqueous base-catalyzed process using micelles of cationic surfactants as templates. The pore size could be increased by increasing the volume of the micelles. That was accomplished by two methods. First, pore sizes up to 40 Å were achieved by increasing the length of the hydrophobic tether of the cationic surfactant. This approach, however, is limited by the fact that the ratio of the volume of the hydrophobic tether to the area of the ionic head has to be within certain limits. In a second approach, the pore size was increased up to 100 Å by using 1,3,5-trimethylbenzene (TMB) to swell the hydrophobic volume of the template (MCM-41 material). Further increase in the concentration of TMB, instead of expanding the pores, lead to materials with less order. On the other hand, variable amounts of the template (surfactant) gave different pore morphologies varying from a two-dimensional hexagonal (MCM-41 material) to three-dimensional cubic (MCM-48) to lamellar (MCM-50 material, with poor structural integrity).

In addition to their intrinsic practical interest, the M41S class of materials set a paradigm in the use of supramolecules (as opposed to single molecules) as structure-directing agents (templates). In 1998 with Stucky introduced large amphiphilic triblock copolymers as templates, as for example poly(ethyleneoxide)-block-poly(propyleneoxide)-block-poly(ethyleneoxide) in acid media, yielding the so-called SBA-class of mesoporous silicas. Such polymer-templated mesoporous silicas generally have pore sizes up to 300 Å and thicker walls than MCM-41-type materials.

In the meantime, a promising area of application of porous monolithic silica that receives much attention is in separations. Monolithic HPLC columns for example are attractive because they overcome the pressure drop problem of particle-packed columns. The first silica-based monolithic columns with a well-defined pore structure were reported by Nakanishi and Soga in 1991. Those columns are characterized by a higher total porosity and permeability compared to packed HPLC columns, allowing operation at low pressures, yet at higher flow rates, thus reducing the analysis time drastically. Recently, Nakanishi and co-workers modified Stucky's method for SBA-15/MCF materials. Nakanishi's approach was to reduce the amount of solvent (aqueous acid) used in Stucky's process thus obtaining gels rather than precipitates. In Nakanishi's method, the gelation solvent (water) was removed at 60° C. under ambient pressure, and the templating agent (Pluronic P123™, obtainable from Merck) was removed by calcination at 650° C., which can lead to up to 50% volume shrinkage.

### SUMMARY

An exemplary embodiment provides a method of forming a monolithic silica gel. The method includes the steps of forming a gel including a tetra-alkoxysilane in the presence of at least one templating agent and at least one expanding agent under acidic conditions; and removing at least a portion of the templating agent from the gel by extraction with a solvent.

Another exemplary embodiment provides a nanoencapsulated monolithic silica gel. The gel includes a silica matrix that has nanostructures and that has surfaces surrounding mesopores and surfaces surrounding macropores. Further, there is an encapsulating layer coating on at least a portion of the silica matrix surfaces surrounding mesopores and on at least a portion of the surfaces surrounding macropores.

A further exemplary embodiment provides a nanoencapsulated silica gel that has a silica matrix with surfaces surrounding mesopores and surfaces surrounding macropores. A polymer coating is formed on at least a portion of the surfaces surrounding mesopores and on at least a portion of the surfaces surrounding macropores. In addition, the nanoencapsulated silica gel has a density less than about 0.71 g cc⁻³ and an ultimate compressive strength greater than about 760 MPa. In a variation of this embodiment, the nanoencapsulated silica gel may have mesoporous worm-like silica building blocks at least partially or completely coated with polymer and at least partially or completely filled with polymer. In another variant, the polymer may have at least one monomer selected from the isocyanates. In a further variation, the yield strength may be greater than about 36 MPa at a strain of about 0.02%.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 illustrates a process flow diagram;

FIG. 2 is Table 1, a table that provides preparation conditions for exemplary embodiments;

FIG. 3 provides Table 2 which summarizes physical property data of samples in accordance with the Examples;

FIG. 4 is Table 3, which provides physical properties of exemplary embodiments made in accordance with Examples;

FIG. 5 is an exemplary embodiment of a chemical reaction flow scheme for making nanoencapsulated silica gels;

FIG. 6. illustrates IR data of various samples made in the Examples;

FIG. 7. shows TGA and DSC data for ordered (MP4-T045) and MCF (MP4-T310 and X-MP4-T310-3) monoliths;

FIG. 8. illustrates N₂ sorption isotherms for the samples made according to the Examples;

FIG. 9. are low resolution SEM of samples as shown in Tables 1 and 2 (FIGS. 2 and 3);

FIG. 10 illustrate powder XRD patterns of samples as indicated in the Examples;

FIG. 11. show high resolution FESEM of MP4-T045 (A) and of X-MP4-T045 (B);

FIG. 12 illustrate TEM of MP4-T045 (A) and of X-MP4-T045 (B);

FIG. 13 show a graph of compressive stress vs. compressive strain curves of two X-MP4-T310-1 samples. At 0.02% strain offset, the yield strength was about 36 MPa while the Young's modulus was estimated at about 1.106 GPa; and

FIG. 14 shows comparative density increase as a function of the concentration of the di-isocyanate (Desmodur N3200) in the nano-encapsulation bath. (Data for the base catalyzed silica aerogels (density of native aerogel monoliths: 0.17 g cm⁻³) from reference N. Leventis, et al., Nano Letters, 2 (2002) 957. Density of the X-MP4-T310 series of samples from Table 2 (density of native MCF monoliths: 0.19 g cm-3)).

### DETAILED DESCRIPTION

In the specification and claims, the term “monolithic” as it applies to products formed from nanostructures (including, without limitation nanoparticles and worm-like hollow building blocks) includes three-dimensional assemblies of nanostructures that may be reinforced with a polymer coating on surfaces surrounding mesopores and surfaces surrounding macropores to thereby form a cohesive, unitary structure of a predetermined configuration. The cohesive structure is sized greater than powders or particulates, and may be shaped and/or sized to substantially conform to a predetermined shape. Thus, for example, the monolithic structure may be a predetermined shape that is a panel, a sphere, a cylindrical shape, etc. as required. In the specification and claims, the term “templated” as it refers to a silica gel relates to a silica gel prepared in the presence of a surfactant resulting in an arrangement of nanosized and/or micro-sized constituents of the silica gel, such as nanoparticles of silica or entangled hollow, worm-like building blocks or randomly intersecting planes of silica.

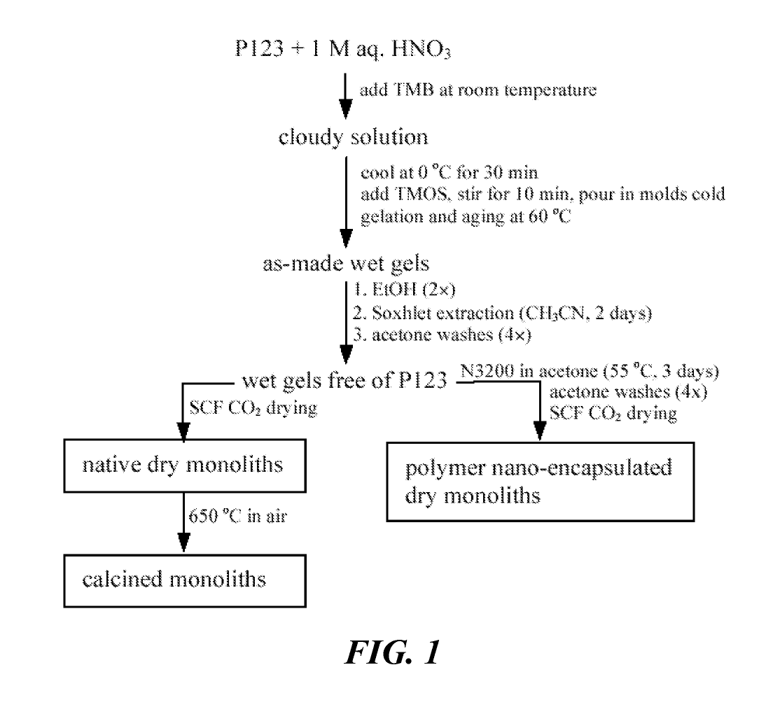

An exemplary embodiment provides a method of making templated silica gels while minimizing shrinkage, reducing cracking, and significantly increasing the mechanical strength and reproducibility of the templated silica gels. In an exemplary embodiment, the native —OH surface functionality of silica is used as a template that directs conformal polymerization of aan isocyanate (or di- or tri-isocyanate) on the macro- and mesoporous surfaces of the gel matrix. Bi-continuous macro-/mesoporous monolithic wet-gels may, for example, be prepared by Nakanishi's modification of Stucky's method using Pluronic P123™ (a tri-block copolymer with surfactant properties supplied by Merck, molecular weight 5,800) as a templating agent and 1,3,5-trimethylbenzene (TMB) as an expanding agent. FIG. 1 is a process flow chart depicting a common process for wet gel production, followed by wet gels exposure to a solution of a di-isocyanate in acetone. Unreacted di-isocyanate is removed by solvent extraction. This is followed by one of two alternative processes. In one exemplary process embodiment, the isocyanate-treated wet gel is washed with a solvent and dried with carbon dioxide using SCF. The resultant nanoencapsulated, isocyanate-treated templated silica aerogels are monoliths that undergo minimal shrinkage and that maintain the macroporous structure of the native monoliths while being much more robust and stronger than the latter.

Alternatively, as also shown in FIG. 1, the wet gel may be treated in a process that subjects the solvent extracted gel to SCF drying followed by calcination. This process produces a fragile native gel, in contrast to the exemplary embodiment of the other process path described above. The Examples, here below, illustrate results of these two processes.

FIG. 5 is a chemical reaction flow scheme for an exemplary mechanism for the nano-encapsulation of silica with a di-isocyanate derived polymer. According to the exemplary embodiment of the chemistry, the di-isocyanate reacts with silica at the sol gel surfaces. The results in formation of a carbamate which is chemically bonded (covalent in this case) to the silica gel. Water present is adsorbed onto the silica gel, and reacts with the carbamate to provide an amide end group with release of carbon dioxide gas. The amide end group is able to react with another isocyanate molecule (in the solution filling the pores) forming a urea group thus extending the polymer chain that is already attached to the surface through the carbamate group. As a consequence of multiple reactions of this nature at the surface of the silica gel, the gel surface becomes encapsulated in an isocyanate-derived polymer. If sufficient isocyanate is present, the silica gel internal surfaces, which include surfaces of nanostructures of silica, become encapsulated with the polymer. Eventually, some polymer chains may form bridges between adjacent nanostructures resulting in crosslinking.

Exemplary embodiments of templated, polymer-encapsulated macro/mesoporous silica aerogels are strong materials in contrast to the ordinarily encountered fragile aerogels. For example, exemplary embodiments may have an ultimate compressive strength more than about 100 times that of a comparable but not polymer nanoencapsulated aerogel. The fact that morphologically different materials of about the same density show different yield points and compressive strengths indicates that the network morphology may influence the mechanical properties of monolithic nanoencapsulated silica aerogels.

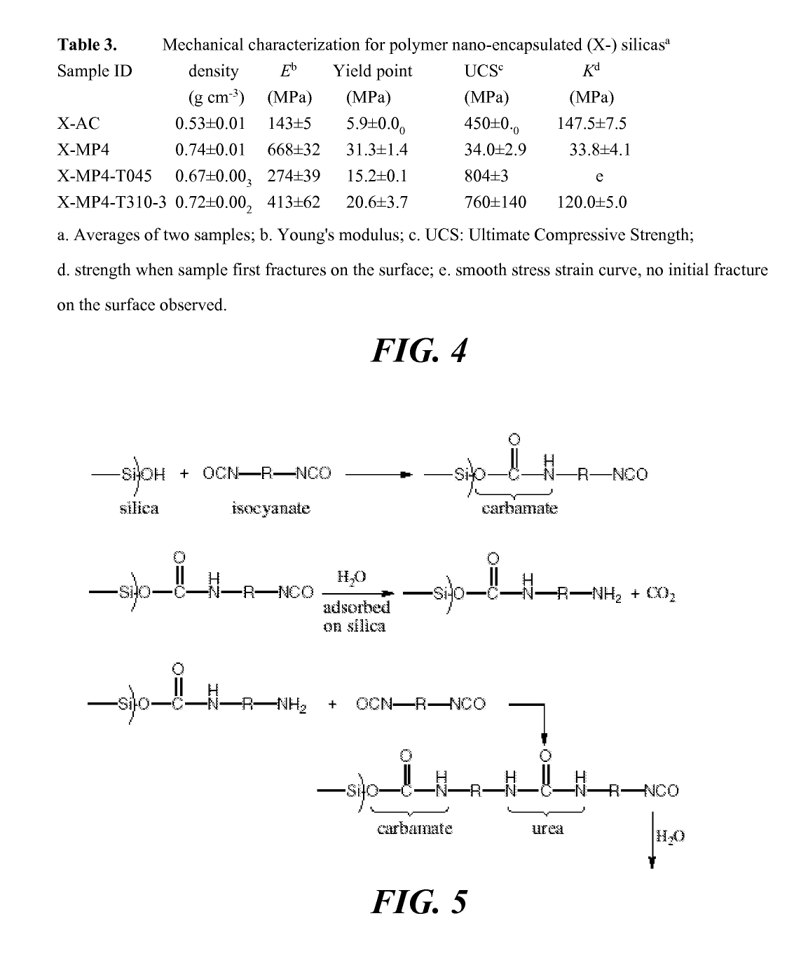

In exemplary embodiments, there are provided monolithic, templated, silica-derived, co-continuous, mesoporous cellular foams (MCFs) in monolithic form that have internal surfaces at least partially or completely coated with isocyanate-derived polymers. These silica MCFs undergo minimal shrinkage upon drying with SCF-CO₂, their preparation involves no high-temperature treatment (calcinations), and they are extremely robust in comparison to aerogels. The MCFs may have a density increase of up to about 3-fold upon polymer encapsulation, and may lose their mesoporosity but they retain all the apparent macroporosity (as determined by SEM and TEM). In addition, they demonstrate high mechanical strength, as indicated in FIG. 4, Table 3.

An exemplary embodiment provides a method of forming a monolithic silica gel. The method includes the steps of forming a gel including a tetra-alkoxysilane in the presence of at least one templating agent and at least one expanding agent under acidic conditions; and removing at least a portion of the templating agent from the gel by extraction with a solvent. In variations of this embodiment, the gel may include surfaces surrounding mesopores and surfaces surrounding macropores. Further, the method may include the step of contacting said surfaces surrounding mesopores and surfaces surrounding macropores with an isocyanate-containing reagent and polymerizing a coating onto the surfaces surrounding mesopores and the surfaces surrounding macropores. In addition, the templating agent is selected from surfactants and the expanding agent is selected from hydrocarbons. The templating agent and the expanding agent are removed by solvent extraction after gelation.

Another exemplary embodiment provides a nanoencapsulated monolithic silica gel. The gel includes a silica matrix that has nanostructures and that has surfaces surrounding mesopores and surfaces surrounding macropores. Further, there is an encapsulating layer coating on at least a portion of the silica matrix surfaces surrounding mesopores and on at least a portion of the surfaces surrounding macropores. In a variation of this embodiment, the encapsulated layer may include a polymer having at least one monomer selected from di-isocyanate, tri-isocyanate and poly-isocyanate. Further, the nanostructures may be microscopic worm-like building blocks that have macropores. These macropores may be at least partially or completely coated with polymer and at least partially or completely filled with polymer. In another aspect, the density of the nanoencapsulated may have a density is less than about 0.71 g/cc. In this aspect, the ultimate compressive strength may be greater than about 760 MPa. In a yet further variation, the polymer may make up from about 65 to about 85 wt % of the monolithic nanoencapsulated silica gel.

A further exemplary embodiment provides a nanoencapsulated silica gel that has a silica matrix with surfaces surrounding mesopores and surfaces surrounding macropores. A polymer coating is formed on at least a portion of the surfaces surrounding mesopores and on at least a portion of the surfaces surrounding macropores. In addition, the nanoencapsulated silica gel has a density less than about 0.71 g cc⁻³ and an ultimate compressive strength greater than about 760 MPa.

Exemplary embodiments may be usefully employed in a variety of fields. For example, taking advantage of the very high ultimate compressive strength, embodiments may be used to make superior body armor for police and other physical protection applications and in run flat tires, for example. The high mechanical strength combined with macroporosity make exemplary thin film embodiments suitable for liquid and gas filtration applications. Taking advantage of the monolithic nature and the macroporosity, exemplary embodiments may be used as media in chromatography columns. Exemplary embodiments may be used in lightweight thermal insulation, as acoustic insulation, as catalyst supports, in dielectrics in electrodes for fuel cells or other purposes, in optical sensors, in aircraft structural components, in polymer matrix composites, and a host of other applications.

### EXAMPLES

Materials: Acetone, acetonitrile, and alcohol were all purchased from Pharmco chemical company (Brookfield Conn., 06804), Nitric acid was obtained from Sea Star Chemical Inc. (Pittsburgh, Pa. 15275), and TMOS was supplied by Sigma Aldrich (St. Louis Mo., 63103), while Pluronic P123™ was supplied by Acros Organics (New Jersey). Research samples of Desmodur N3200 di-isocyanate were provided by Bayer (Pittsburgh, Pa. 15205). All chemicals were used as received without any purification.

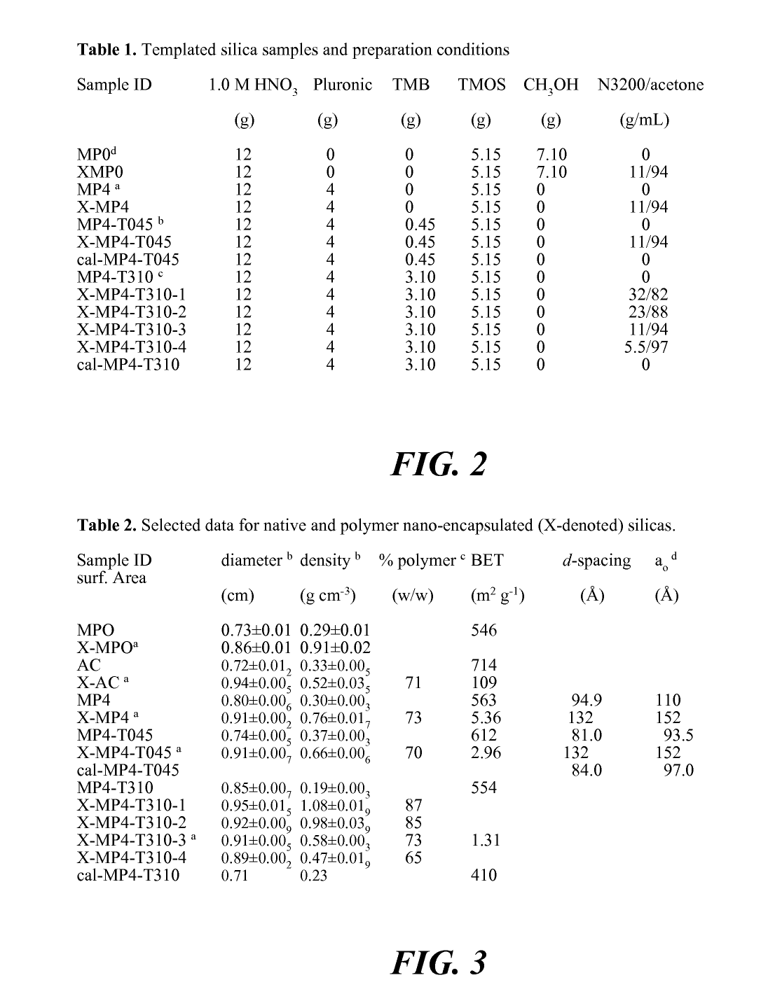

Preparation of templated samples: In a typical procedure, 4.0 g of Pluronic P123 (tri-block co-polymer: PEO₂₀PPO₇₀PEO₂₀) was dissolved in 12 g of a 1.0 M aqueous solution of nitric acid, and a given amount of TMB was added under magnetic stirring at room temperature. Solutions after addition of Pluronic P123 are clear and after TMB look turbid. After stirring for 30 min at room temperature, samples were cooled to 0° C. and 30 min later the same amount of TMOS (5.15 g) was added to each sample under vigorous stirring. FIG. 2, Table 1 summarizes the synthetic conditions of different gels. Following Nakanishi's notation, MP4 samples used no TMB; MP4-T045 samples used 0.45 g TMB; and, MP4-T310 samples used 3.10 g of TMB. After stirring for 10 more min at 0° C., the resultant homogeneous (albeit not clear) solutions were poured into polypropylene molds (Wheaton polypropylene Omni-Vials, Part No. 225402, 1 cm in diameter). Molds were sealed with plastic cups and kept at 60° C. for gelation. The resulting wet gels were aged at 60° C. for about 5 times the gelation time (see footnote in Table 1) and were removed from the molds into ethanol. Such as-made wet gel monoliths were washed with ethanol (2×, ˜8 h each time) and subsequently went through Soxhlet extraction (2 days; CH₃CN). After the Soxhlet extraction, wet gels were washed with acetone (4×, ˜8 h each time) and were either dried with supercritical CO₂ to yield native dry silica monoliths, or were placed in solutions of di-isocyanate (Desmodur N3200) in acetone.

Preparation of Non-Templated Samples: in Order to Evaluate the Effect of Templating on the ability of acid-catalyzed samples to get reinforced by reaction with a diisocyanate, we also prepared non-templated acid-catalyzed samples by a modification of literature procedures. Those samples are designated as AC and X-AC. Specifically, a solution containing 7.4 mL CH₃OH, 14.6 mL of a 4.6 pH potassium hydrogen phthalate buffer (0.05M) and 40 μL HCl was added to a second solution consisting of 9.0 mL CH₃OH and 9.4 mL TMOS, and the mixture was stirred thoroughly. The sol was poured into polypropylene molds, and was left to gel and age for 24 h. Gels were removed from the molds and were washed successively with CH₃OH (2×, 12 h each time) and CH₃CN (3×, 24 h each time). Those samples were either dried with SCF CO₂ or were placed in a solution of Desmodur N3200 in acetonitrile (9.86 g in 100 mL solvent) for 24 h for equilibration, followed by heating at 70° C. for 24 h, 4 CH₃CN washes and drying with SCF CO₂.

Methods and Equipment: Infrared spectroscopy (IR) was conducted with powders in KBr pellets using a Nicolet Nexus 470 FT-IR Instrument. Thermogravimetric analysis (TGA) was conducted with a Netzsch Instrument, model STA 409 C, under argon and with a heating rate of 10° C. min⁻¹. Differential scanning calorimetry (DSC) was conducted with a TA Instruments Model 2010 apparatus under nitrogen, and a heating rate of 10° C. min⁻¹. For Scanning Electron Microscopy (SEM) samples were vapor-coated with Au and low-resolution SEM was conducted with a Hitachi S-570 microscope, while high resolution FESEM with a Hitachi S-4700 field emission instrument. Transmission Electron Microscopy (TEM) was conducted with a Philips CM12 instrument employing a Lanthanum hexaboride filament operating at 100 kV accelerating voltage. For X-Ray Diffraction (XRD), samples were examined using a Phillips X'Pert Materials Research Diffractometer (model PW3040/60) using Cu Kα radiation (λ=1.54 Å). The incident beam prefix module was an x-ray mirror (PW3088/60) equipped with a 1/32° fixed slit. The diffracted beam prefix module was a 0.18° parallel plate collimator (PW3098/18) equipped with a sealed proportional detector (PW3011/20). The instrument was operated in the continuous mode with a step size of 0.02° and a counting time of 25 seconds per point. Quasistatic mechanical characterization was conducted as described in the literature. Surface analysis was conducted with a Micromeritics 2020 Analyzer at Micromeritics, Norcross, Ga.

Preparation of Native and Polymer Nanoencapsulated Monoliths. Several Types of wet-gel monoliths templated with Pluronic P123 were prepared in the presence or absence of TMB as expanding agent via a modification of Nakanishi's acid catalyzed procedure, and are named following Nakanishi's notation (FIG. 2, Table 1). The relative proportions of reagents were left equal to those reported by Nakanishi, but processing conditions were altered in order to facilitate low-temperature processing and obtain large defect-free monoliths. A significant difference from Nakanishi's method is the removal of the Pluronic P123 template by Soxhlet extraction (CH₃CN) rather than (1) drying at 60° C. followed by (2) calcination. For comparison purposes, we also prepared non-templated acid-catalyzed wet gels by two methods: (a) TMOS (5.15 g) was mixed with 1.0 M aqueous HMO₃ (12 g) and 7.10 g of methanol. Those samples are designated by MP0 and (b) according to a modification of the procedure published by C. I. Merzbacher et al. in JNL of Non Crystalline Solids, v. 224, 892, (1998). Those samples are denoted as AC. All wet gels were either solvent exchanged and dried with liquid CO₂ taken out supercritically, or they were subjected to a polymer nanoencapsulation process that involved treatment with a solution of Desmodur N3200 (a hexamethylene di-isocyanate oligomer supplied by Bayer).

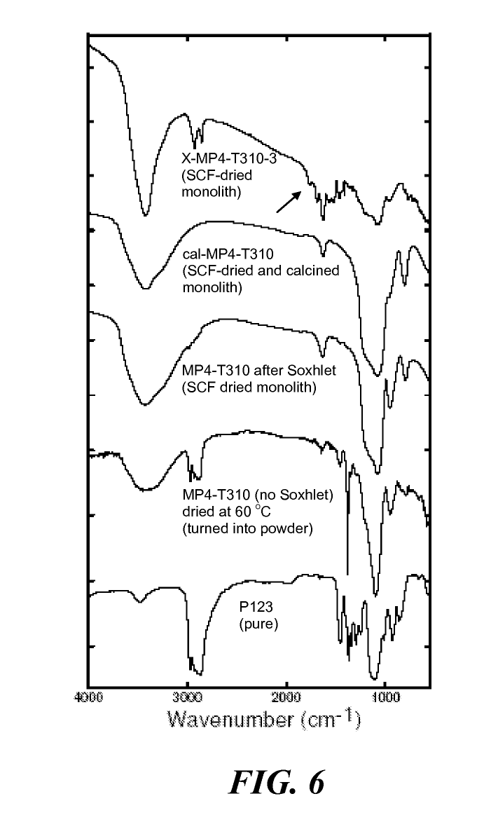

Macroscopic, chemical, and gravimetric characterization of native and polymer nanoencapsulated monoliths.: FIG. 6 shows typical IR spectra at the various stages of processing. As expected, air-dried samples show all features assigned to the tri-block co-polymer template, namely C—H stretches in the 2850-3000 cm⁻¹ range, C—H bending vibrations in the 1350-1450 cm⁻¹ range and a strong C—O stretch at ˜1100 cm⁻¹. The first two of those absorbance features disappear completely in calcined samples, while they become negligibly small in samples after Soxhlet extraction, indicating that the surfactant has been removed quantitatively. IR spectra of samples treated with Desmodur N3200 confirm massive uptake of polymer by showing C—H stretches just below 3000 cm⁻¹, as well as the characteristic diazetidine dione carbonyl stretch of Desmodur N3200 at 1767 cm⁻¹. The features due to the polymer dominate the spectrum.

The density of the polymer-treated samples, the amount of Desmodur N3200 and the volume of the acetone were varied as shown in FIG. 2, Table 1. After allowing a 24 h equilibration time in the corresponding Desmodur N3200 solutions, samples were heated together with the surrounding di-isocyanate solutions at 55° C. for 3 days. After four more acetone washes (˜8 h each time) to remove unreacted di-isocyanate, gels were dried with SCF CO₂ to crosslinked monoliths. For comparison with the literature, native dry silica monoliths of MP4-T045 and MP4-T310 samples were also calcined at 650° C. for 6 h in air to yield calcined monoliths. Samples treated with isocyanate are designated as X— and calcined samples as cal-.

Owing to polymer uptake, the density of isocyanate treated samples has more than doubled relative to the density of their native counterparts (see FIG. 3, Table 2). By the same token, cross linked samples have undergone less shrinkage during processing (refer to diameters in FIG. 3, Table 2). The percent weight of the polymer in the isocyanate-treated samples is calculated from the relative density increase and the relative diameter data according to equation. 1, and is also cited in Table 2 (ρ stands for the sample density):

$$polymer weight percent = ⌊ 1 - {[ {( \frac{{diameter}_{x}}{{diameter}_{native}} )}^{3} ( \frac{{ρ}_{x}}{{ρ}_{native}} ) ]}^{- 1} ⌋ \times 100 \qquad ( 1 )$$

subscript “X” denotes polymer-treated samples). With the concentration of Desmodur N3200 in the processing bath kept about constant, samples seem to end up consisting of ˜70-73% w/w polymer.

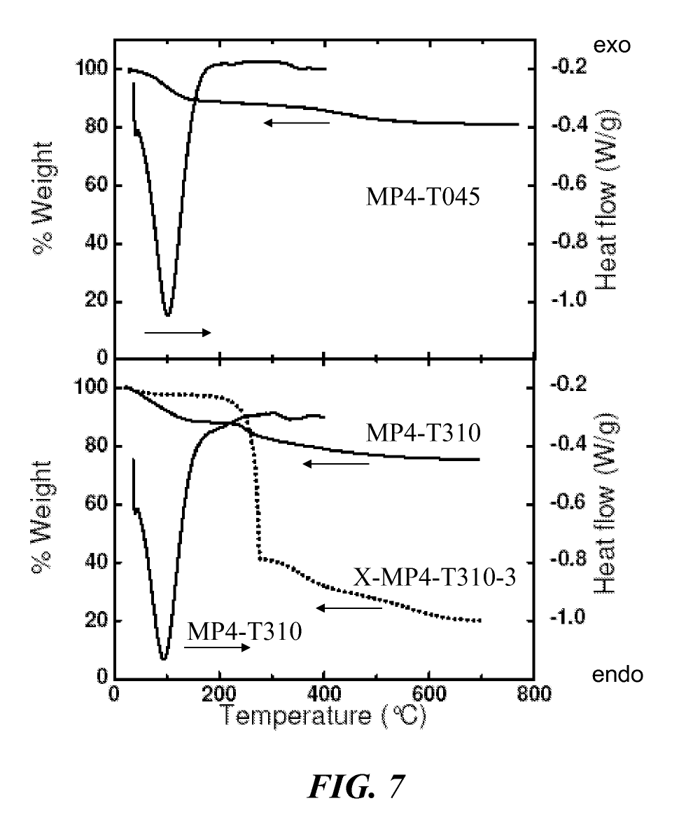

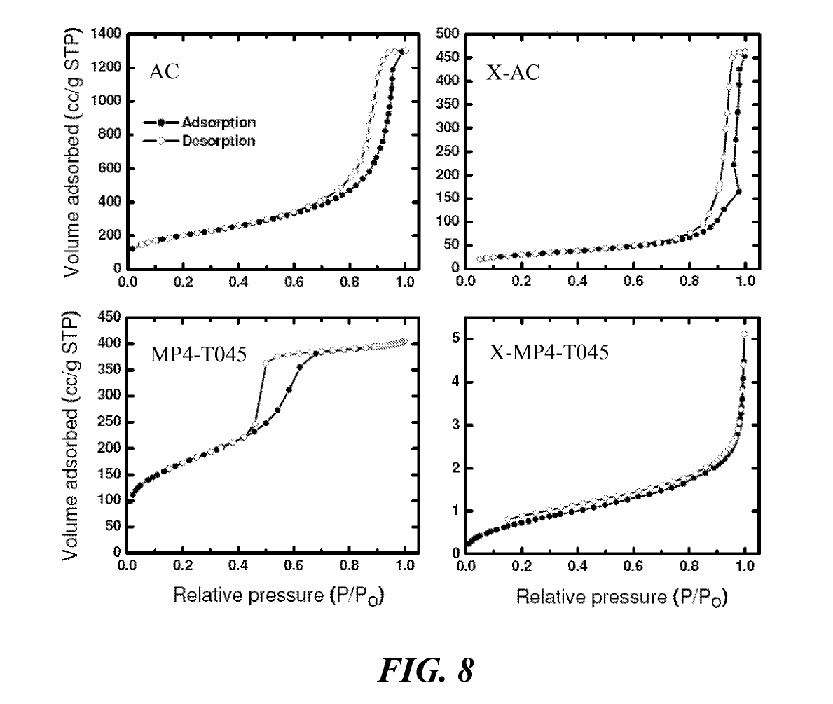

Typical thermogravimetric analysis data (TGA, FIG. 7) of native MP4-T045 and MP4-T310 samples show a first gradual mass loss below 100° C. Differential scanning calorimetry (DSC) shows an endotherm at ˜100° C. TGA and DSC data together indicate that native samples retain up to ˜15% w/w of gelation water, remaining adsorbed even after all processing including SCF CO₂ drying. Subsequent mass loss of ˜10% w/w above 300° C. corresponds to organic matter, presumably mostly ethers of ethanol (—Si—O—CH₂CH₃) formed during the ethanol wash steps. (Pluronic P123 on silica decomposes at ˜145° C.) After treatment with isocyanate, the weight loss below 100° C. is only ˜3%, while the major mass loss occurs in the 250-300° C. range, consistently with decomposition of polyurethane/polyurea. Based on TGA, the percent weight content of polymer in the corresponding dry samples is ˜70%, in good agreement with information provided by density and dimension change data (FIG. 3, Table 2).

Surface area characterization of native versus polymer nanoencapsulated monoliths: Surface area analysis was conducted by nitrogen sorption porisometry and data are cited in FIG. 3, Table 2. FIG. 7 shows representative isotherms for templated samples (MP4-T045 and X-MP4-T045) vs. our non-templated samples (AC and X-AC). Both non polymer treated samples (MP4-T045 and AC) show type IV isotherms, characteristic of mesoporous materials. The non-templated sample (AC) shows an H1 hysteresis type for unobstructed adsorption-desorprtion processes, while the templated sample (MP4-T045) shows a H2 hysteresis that characterizes ink-bottle pores. Importantly, the isocyanate treated samples behave quite differently. The non-templated sample (X-AC) continues to show a type IV isotherm, implying that the mesoporous structure is retained, while the templated sample (X-MP4-T045) shows a type II isotherm for macro or non-porous material, with H3 hysteresis, characteristic of slit pores. This behavior is general for all templated samples, and indeed, BET surface areas track those realizations and all templated samples show very small values for internal surface areas after polymer treatment. In contract, non-templated samples (X-AC) show compromised but still significant (109 m² g⁻¹) surface areas even after polymer treatment. Yet, another important feature of the treated samples is the fact that the C parameter (an empirical constant related to the difference between the heat of adsorption on the bare surface and on the following layers) decreases from values in the range of 114-212 for native samples to values in the range of 24-54 for polymer-treated (X—) samples, indicating a drastic decrease in surface polarity, as expected by coating silica with an organic polymer.

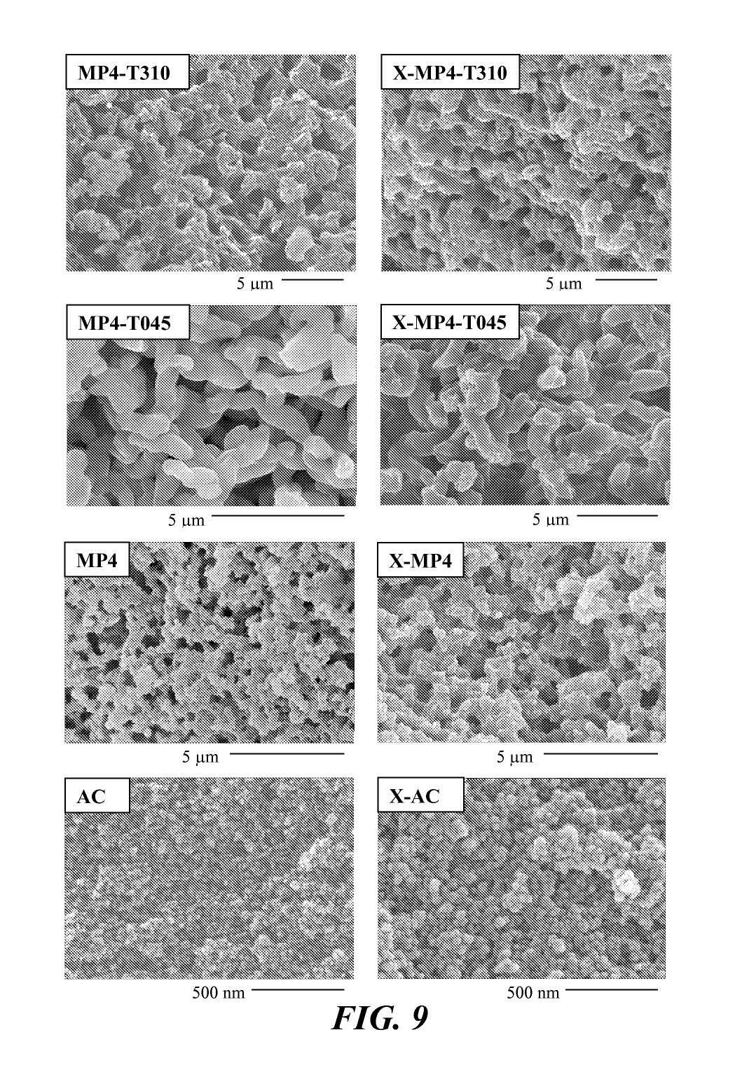

The effect of polymer nano-encapsulation on the micro-morphology of templated silica monoliths: Microscopically (by SEM) all samples prepared using Pluronic P123 as templating agent, with or without swelling agent (namely samples MP4, MP4-T045 and MP4-T310) show macroporosity, with pore sizes in the order of microns (FIG. 9), and polymer nano-encapsulation does not have any obvious impact on the macroporosity. Control samples prepared with no templating agent (AC samples) appear fibrous (as expected for acid-catalyzed silica), and despite the density increase (FIG. 3, Table 2) polymer addition does not have an effect on the general structure.

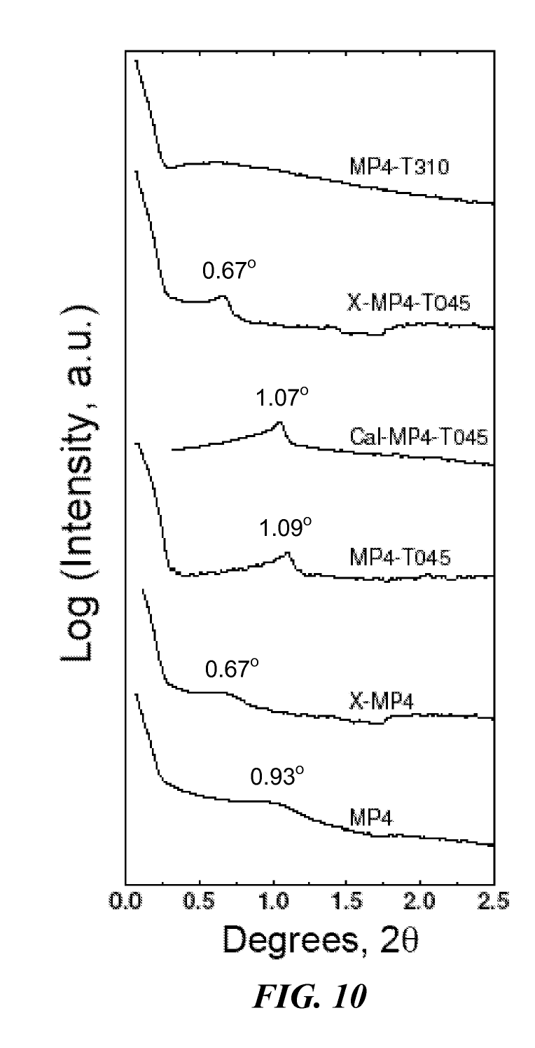

XRD spectra from MP4 and MP4-T045 samples and their corresponding polymer-treated counterparts show small angle reflections, consistently with the presence of ordered mesopores (FIG. 10). For AC and X-AC samples we did not use a templating agent, so no organized mesoporosity is expected. On the other hand, MP4-T310 samples used surfactant together with a high concentration of swelling agent (TMB) and showed only a broad undefined pattern, as expected from MCF materials lacking ordered mesoporosity. Assuming that the XRD reflections are from the (100) surface, d-spacings are calculated based on Bragg's law (λ_{Cu Kα}=2 d sin θ) and are included in FIG. 3, Table 2. Assuming a hexagonal structure, from the d-spacings we can calculate the unit cell parameter aₒ (aₒ=2×d(100)/√3), which is always considerably larger in nanoencapsulated aerogel than in native samples (FIG. 3, Table 2).

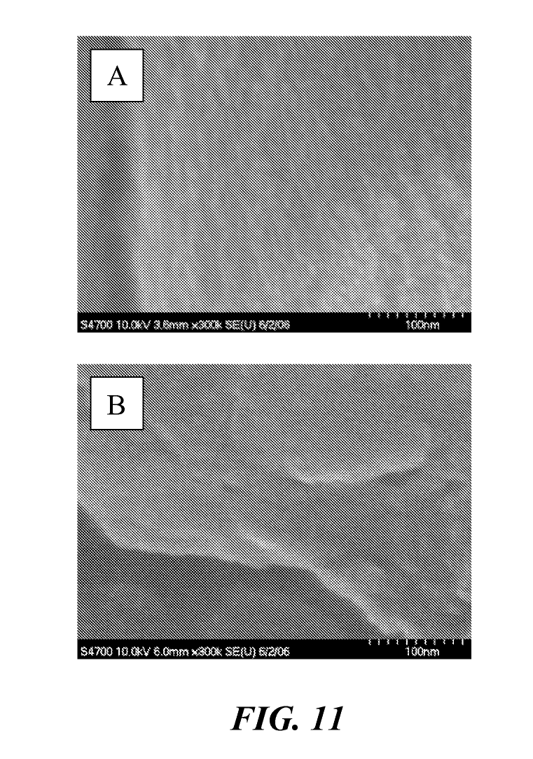

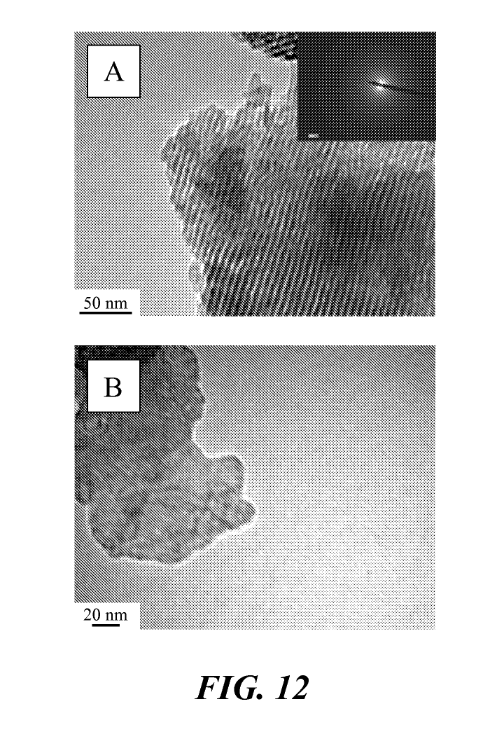

The presence of an ordered nanostructure in, for example, the MP4-T045 samples is also confirmed by high resolution FESEM and TEM. FIG. 11A shows long parallel grooves and bumps running along the surface of the worm-like objects (FIG. 9) that comprise the building blocks of the macropores. These features imply that those objects consist of tightly packed tubes embedded in silica. This is confirmed by TEM (FIG. 12A), whereas the diffraction pattern of the electron beam (FIG. 12A-Inset) confirms the two-dimensional organization of the mesopores. Polymer in X-MP4-T045 samples covers the surface of the worm-like objects erasing the surface registration of the underlying tubes (FIG. 11B). In TEM (FIG. 12B), the tube structure is very faint, if visible at all.

### Mechanical Properties of Native and Nanoencapsulated Templated Silicas

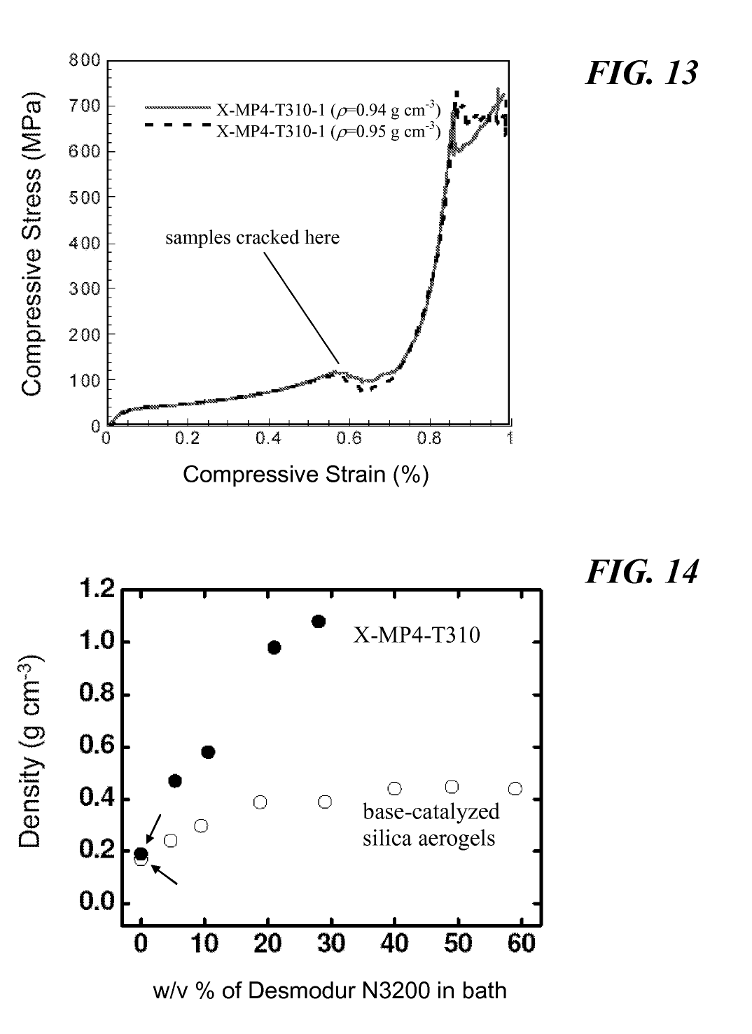

In analogy to silica aerogels, isocyanate-treated MCFs are mechanically very strong materials. Quasi-static mechanical compression testing was conducted as described in -the literature Compressive stress as a function of compressive strain for representative X-MP4-T310-1 samples are shown in FIG. 13 and data for all types of samples are summarized in Table 3. All samples show qualitatively similar stress-strain curves, with a well-defined elastic range up to ˜4-5% strain with a yield stress that appears to depend on the sample morphology. The elastic range is followed by inelastic hardening. Samples generally first show some fracture on their surface at about 50-60% strain (the value K in FIG. 4, Table 3 reports the strength at that point), but the ultimate compressive strength (at ˜80% strain) is much higher than the point where first signs of fracture appear. Initial fracture on the surface is avoided, and smooth stress-strain curves up to the point of ultimate failure are obtained by sanding of the curved cylindrical surfaces of the samples before compression testing. Samples for which data are shown in FIG. 13 had not been sanded.

Our interest in templated silicas stems from our methodology of reinforcing three-dimensional (3D) sol-gel superstructures by conformal polymer nanocasting over their entire skeletal framework. In that regard, one of the most important, but also far reaching applications of sol-gel materials, is in separations. Monolithic HPLC columns are already marketed by Merk Co. under the trade mane Chromolith™. In that environment, we recognized that by nano-encapsulation of the skeletal framework of such monolithic HPLC columns we will realize two benefits: (a) increased mechanical strength able to tolerate much higher pressures, thus accelerating flow rates; and, (b) polymer-like surface properties for a porous morphology innate to silica. Thus, we became aware of Nakanishi's modification of Stucky's method of producing macroporous 3D systems of interconnected voids (MCF silicas) in monolithic form. Dry monoliths could not be obtained by heating wet gels at 60° C., either before or after quantitative removal of the templating agent by Soxhlet extraction. In both cases, wet gel monoliths shrunk and cracked upon drying, yielding a few small irregular pieces and coarse powder. It is theorized without being bound that the observed collapse is probably caused by surface tension forces exerted upon the skeletal framework by the evaporating solvent. Accordingly, drying may be carried out with SCF CO₂.

The resulting templated monoliths had densities in the 0.19-0.37 g cm⁻³ range, namely in the same range as typical native aerogels. All templated silicas of this study show macroporosity by SEM and fairly high surface areas (550-612 m² g⁻¹, Table 2), which is consistent with a large mesoporosity as well. Ordered mesoporosity has been confirmed by XRD (FIG. 10) and TEM (FIG. 12).

All silicas of the study are surface-terminated with hydroxyl groups (notice in FIG. 6 the similarity in the IR spectra around 3500 cm⁻¹ of calcined and simply dehydrated samples). On the other hand, the gradual TGA mass loss up to 100° C. and the well-defined endotherm in the DSC at ˜100° C., indicate that dry samples contain ˜15% w/w of strongly-adsorbed water (even after the SCF-CO₂ drying process). According to exemplary embodiments, the surface OHs and adsorbed water permit a diisocyanate introduced in the macro/mesopores, to react with the surface forming surface-bound urethane —Si—O—CO—NH—R—NCO, while dangling isocyanates —NCO will be hydrolyzed by adsorbed water at their vicinity, leading to dangling amines. (The by-product is CO₂.) Subsequently, amines will react with more diisocyanate in the pores, leading to urea and a new dangling —NCO. The process is summarized in FIG. 5, Scheme 2 and results in formation of molecular tethers bridging reactive sites (i.e., OH groups) on the framework. Indeed, silica uptakes polymer (FIG. 2) and the density increases by a factor of 2-5, depending on the type of silica and the amount of di-isocyanate in the bath. Equation 2:

$$average no . of monomer units in a tether = \frac{{ρ}_{b , crosslinked} - {ρ}_{b , native}}{{MW}_{monomer} S {ρ}_{b , crosslinked}} \times \frac{1}{{10}^{- 6}} \qquad ( 2 )$$

Equation 2 calculates the number of monomer units in an average polymeric tether using density increase and BET surface area (S) data, assuming that monolayer coverage with a small molecule requires 10⁻⁶ mol m⁻². Thus, for example, it is calculated that the average polymer tether in the X-MP4-T310-3 samples consists of 5.3 monomer units (MW_{Desmodur N3200}=452; for this calculation as S we use the average BET surface area before and after crosslinking).

FIG. 9 is a process flow scheme for an exemplary mechanism for the nano-encapsulation of silica with a di-isocyanate derived polymer.

Density continues to increase as a function of the concentration of the di-isocyanate in the nano-encapsulation bath. This appears to contrast with observations of base-catalyzed silica aerogels of about the same density as the MP4-T310 samples. However, the difference is that samples of were made in water and as a result they contain up to 15% w/w water even after SCF CO₂ drying, while the other base-catalyzed aerogels were made in methanol and contained only 3-4% w/w water. The density increase as a result of the reaction of those base-catalyzed samples with di-isocyanate leveled off at ˜0.5 g cm⁻³. Here, the density of X-MP4-T310 samples increases to over 1 g cm⁻³. FIG. 14 compares the density increase as a function of the diisocyanate concentration (w/v) in the bath for two kinds of samples. Based on the mechanism of Scheme 2, it is reasonable to suggest that during reaction with diisocyanates, in the case of base-catalyzed silica aerogels made in methanol, surface-adsorbed water is the limiting reagent, while in the case of templated silica made in water, the limiting reagent is the diisocyanate.

According to N₂ sorption porosimetry, all templated/polymer-treated samples loose their mesoporous surface area. This can be due either to clogging of the entrances to the pores (ink-bottle model) or to complete filling of the pores by polymer. If we had simple clogging of the pore entrances, we would still expect a well-defined tubular pattern in the TEM of the X-MP4-T045 samples. The fact that the organization is still present (by XRD) but the tubes are not visible by TEM implies that the pores have been filled with polymer. This is also supported by the fact that reaction of the diisocyanate and accumulation of polymer start from the silica surface and are relatively slow processes, thus giving time for more monomer to diffuse along the short distance from the macropores into the tubular mesopores leading to a progressing clogging starting from the perimeter and working towards the center.

Upon drying, native silica gels shrink more than the monolithic silica embodiments. The X-samples are physically larger than their native counterparts and XRD data show that tubular mesopores in samples with ordered mesoporosity come closer together after drying of native versus X-samples (specifically, note in FIG. 3, Table 2 the unit cell parameter difference for MP4 and X-MP4 on one hand, and MP4-T045 and X-MP4-T045, on the other). However, the ratios of the sample diameters (1.14 for X-MP4/MP4 and 1.23 for X-MP4-T045/MP4-T045) are significantly lower than the ratios of the corresponding unit cell parameters (1.38 for X-MP4/MP4 and 1.63 for X-MP4-T045/MP4-T045). This individual microscopic worm-like building blocks that define the macropores (FIG. 9) shrink a little more upon drying than the structure as a whole. This is not difficult to reconcile based on the fact that —OH groups in the internal curved surfaces of the mesoporous tubes are closer to one another, and interact stronger through, for example, hydrogen bonding. From that perspective, either conformal coating of the internal tube surfaces, or complete filling of the pores with the di-isocyanate-derived polymer (FIG. 5, Scheme 2) uses up the hydroxyl groups, and stabilizes the structure against partial collapse.

One of skill in the art will readily appreciate the scope of the invention from the foregoing and the claims here below, and that the invention includes all disclosed embodiments, modifications of these that are obvious to a person of skill in the art, and the equivalents of all embodiments and modifications, as defined by law.

What is claimed is:

1. A method of forming a monolithic silica gel, comprising the steps of:
forming a gel including a tetra-alkoxysilane in the presence of at least one templating agent and at least one expanding agent under acidic conditions;
removing at least a portion of the templating agent from said gel by extraction with a solvent.

2. The method according to claim 1, wherein said gel includes surfaces surrounding mesopores and surfaces surrounding macropores.

3. The method according to claim 2, further including the step of contacting said surfaces surrounding mesopores and surfaces surrounding macropores with an isocyanate-containing reagent and polymerizing a coating onto the surfaces surrounding mesopores and the surfaces surrounding macropores.

4. The method according to claim 3, further including the step of drying the polymer coated gel.

5. The method according to claim 1, wherein the templating agent comprise a surfactant.

6. The method according to claim 1, wherein the expanding agent comprises a hydrocarbon.

7. A nanoencapsulated monolithic silica gel, comprising:
a silica matrix comprising nanostructures, the silica matrix having surfaces surrounding mesopores and surfaces surrounding macropores; and an encapsulating layer coating on at least a portion of said silica matrix surfaces surrounding mesopores and on at least a portion of said surfaces surrounding macropores.

8. The monolithic nanoencapsulated silica gel according to claim 7, wherein the encapsulated layer comprises a polymer, the polymer comprising at least one monomer selected from the group consisting of di-isocyanate, tri-isocyanate and poly-isocyanate.

9. The monolithic nanoencapsulated silica gel according to claim 8, wherein said di-isocyanate, or tri-isocyanate comprise respectively a hexamethylene di-isocyanate oligomer or a hexamethylene tri-isocyanate oligomer.

10. The monolithic nanoencapsulated silica gel according to claim 7, wherein the nanostructures comprise microscopic worm-like building blocks.

11. The monolithic nanoencapsulated silica gel of claim 10, wherein the microscopic worm-like building blocks comprise mesopores and form macropores, the macropores at least partially or completely coated with polymer and the mesopores at least partially or completely filled with polymer

12. The monolithic nanoencapsulated silica gel according to claim 7, wherein the density is less than about 0.71 g cc⁻³.

13. The monolithic nanoencapsulated silica gel according to claim 12, wherein the ultimate compressive strength is greater than about 760 MPa.

14. The monolithic nanoencapsulated silica gel according to claim 8, wherein the polymer comprises from about 65 to about 85 wt % of the monolithic nanoencapsulated silica gel.

15. A nanoencapsulated silica gel, comprising:
a silica matrix comprising surfaces surrounding mesopores and surfaces surrounding macropores;
a polymer coating formed on at least a portion of said surfaces surrounding mesopores and surfaces surrounding macropores; and
wherein, said nanoencapsulated silica gel has a density less than about 0.71 g cc⁻³ and an ultimate compressive strength is greater than about 760 MPa.

16. The nanoencapsulated silica gel according to claim 15, wherein the silica gel comprises mesoporous worm-like silica building blocks at least partially or completely coated with polymer and at least partially or completely filled with polymer.

17. The nanoencapsulated silica gel according to claim 15, wherein the silica gel comprises nanostructures of silica at least partially or completely covered with polymer.

18. The nanoencapsulated silica gel according to claim 15 wherein the polymer comprises at least one monomer selected from the isocyanates.

19. The nanoencapsulated silica gel according to claim 15 wherein the polymer comprises a hexamethylene di-isocyanate oligomer.

20. The nanoencapsulated silica gel according to claim 15, wherein the yield strength is greater than about 36 MPa at a strain of about 0.02%.
